(19) United States
(12) Patent Application Publication
(10) Pub. No.: US 2026/0020581 A1
(43) Pub. Date: Jan. 22, 2026

(54) COATING COMPOSITION, FRUIT AND VEGETABLE WITH COATING FILM AND METHOD FOR KEEPING FRESHNESS OF FRUIT AND VEGETABLE

(71) Applicant: Mitsubishi Chemical Corporation, Tokyo (JP)

(72) Inventors: Daichi NISHIMURA, Osaka (JP); Natsuki HIRA, Omihachiman-shi (JP); Atsushi TAKAKI, Yamato-shi (JP)

(73) Assignee: Mitsubishi Chemical Corporation, Tokyo (JP)

(21) Appl. No.: 19/344,770

(22) Filed: Sep. 30, 2025

Related U.S. Application Data
(63) Continuation of application No. PCT/JP2024/013461, filed on Apr. 1, 2024.

(30) Foreign Application Priority Data
Mar. 31, 2023 (JP) 2023-058019
Mar. 27, 2024 (WO) PCT/JP2024/012487

(51) Int. Cl. A23B 7/16

(52) U.S. Cl. CPC A23B 7/16

(57) ABSTRACT

The present disclosure relates to a coating composition containing a sucrose fatty acid ester and a glycerin fatty acid ester, wherein the mass ratio (solid content) of the sucrose fatty acid ester to the total mass of the sucrose fatty acid ester and the glycerin fatty acid ester is 1% or more and less than 100%.

### CROSS-REFERENCE TO RELATED APPLICATIONS

This application is a continuation of International Application PCT/JP2024/013461 filed on Apr. 1, 2024, and claims priority to Japanese application No. 2023-058019 filed on Mar. 31, 2023 and PCT/JP2024/012487 filed on Mar. 27, 2024, the disclosures of all of which are incorporated herein by reference in their entireties.

### TECHNICAL FIELD

The present disclosure relates to a coating composition, a fruit or vegetable having a coating film formed from the composition, and a method for preserving the freshness of a fruit or vegetable.

### BACKGROUND ART

In recent years, packaging materials that can maintain the freshness of food during distribution or storage, such as modified atmosphere (MA) packaging, have been attracting attention.

For example, technology has been proposed in which a layer having a freshness-preserving effect is provided on a film used to package food, and thereby the freshness of the food is maintained (see Patent Literature 1).

In addition, technology has been proposed in which a quality preservation agent is coated directly onto food such as fruits and vegetables to preserve the freshness of the food (see Patent Literatures 2 and 3).

In particular, Patent Literatures 4 and 5 each disclose, as a composition that can be used for forming a protective coating on a substrate, a composition containing a glycerin fatty acid ester, and indicate that the composition can be used for protecting a substrate, for example, a food and/or an agricultural product from a decrease in quality and/or decomposition due to factors such as water loss, oxidation, mechanical decomposition, photolysis, and the growth of mold.

### CITATION LIST

### Patent Literature

Patent Literature 1: JP 2001-171058 A
Patent Literature 2: JP 2018-134115 A
Patent Literature 3: JP 2005-530502 T
Patent Literature 4: JP 2018-534912 T
Patent Literature 5: JP 2021-536457 T
Patent Literature 6: JP 08-056564 A

### SUMMARY

### Technical Problem

In the technology disclosed in Patent Literature 1, since food may come into contact with the packaging film during distribution or storage, the layer having a freshness-preserving effect is also preferably highly safe for the human body.

The methods disclosed in Patent Literatures 2 and 3 have a short freshness preservation period and are not necessarily sufficient for exhibiting freshness-preservation performance.

Furthermore, although the compositions disclosed in Patent Literature 4 and 5 have a freshness-preserving effect, the coatability of the compositions is not necessarily high, and the compositions are difficult to handle.

Patent Literature 6 describes an exocarp damage inhibitor for fruits and vegetables, the exocarp damage inhibitor containing, as an active ingredient, a surfactant having an HLB of 5 or lower. This exocarp damage inhibitor is intended to prevent water from entering through the exocarp of fruits and vegetables, and to effectively prevent damage to the exocarp while preventing the adverse effects of coating with an oil or fat. In Patent Literature 6, while a surfactant alone is not easily dispersed or dissolved in water, this difficulty is overcome by using an emulsifier. The method for producing the exocarp damage inhibitor includes adding a heated and melted surfactant in a heated state to a heated and dissolved emulsifier. Although the method disclosed in Patent Literature 6 prevents damage to the exocarp to some extent, it is considered that further improvements can be made from the viewpoint of preserving freshness.

Thus, an object of the present disclosure is to provide a coating composition that can directly form a coating film having a freshness-preserving function without using a packaging material, a fruit or vegetable having a coating film formed from the coating composition, and a method for preserving the freshness of a fruit or vegetable.

### Solution to Problem

As a result of intensive studies, the present inventors have discovered that the above problems can be solved by using a composition containing at least two types of specific fatty acid esters. The present disclosure has been completed based on this finding.

That is, the present disclosure provides the following aspects:
[1] A coating composition containing a sugar-based surfactant and a glycerin fatty acid ester, wherein a mass ratio (solid content) of the sugar-based surfactant to a total mass of the sugar-based surfactant and the glycerin fatty acid ester is 1% or more and less than 100%, and a content of a glycerin fatty acid ester having three fatty acid ester groups is 50 mass % or less.
[2] The coating composition according to [1], wherein a shear viscosity at a shear rate of 1 s⁻¹ is from 0.1 to 8000 mPa·s.
[3] The coating composition according to [1] or [2], wherein the sugar-based surfactant is a sucrose fatty acid ester.
[4] The coating composition according to any of [1] to [3], further containing an aqueous solvent.
[5] The coating composition according to [4], wherein the aqueous solvent contains water or a mixed solvent of a water-soluble organic solvent and water.
[6] The coating composition according to any of [1] to [5], wherein a concentration of a nonvolatile component is 0.1 mass % or more and 60 mass % or less.
[7] The coating composition according to any of [1] to [6], wherein, in differential scanning calorimetry in which a measurement temperature range is set to −80° C. or higher, a ratio of a total exothermic peak area A₃ to a total endothermic peak area A₂ at 0° C. or higher and 80° C. or lower is 50% or less.
[8] A fruit or vegetable having a coating film formed from the coating composition described in any of [1] to [7].
[9] The fruit or vegetable having a coating film according to [8], wherein the coating film has an average film thickness of 0.1 μm or more and 10 μm or less.
[10] A method for preserving the freshness of a fruit or vegetable, the method including covering a fruit or vegetable with the coating composition described in any of [1] to [7].
[11] The method for preserving the freshness of a fruit or vegetable according to [10], wherein covering with the coating composition is immersing a fruit or vegetable in the composition, or applying or spraying the composition onto a fruit or vegetable.

### Advantageous Effects

According to the present disclosure, a coating composition that can directly form a coating film having a freshness-preserving function without using a packaging material; a fruit or vegetable having a coating film formed using the coating composition, and a method for preserving the freshness of a fruit or vegetable can be proposed.

### DESCRIPTION OF EMBODIMENTS

### Coating Composition

The coating composition of the present disclosure (hereinafter may be referred to as “the present composition”) is a coating composition that contains a sugar-based surfactant and a glycerin fatty acid ester, wherein the mass ratio (solid content) of the sugar-based surfactant to the total mass of the sugar-based surfactant and the glycerin fatty acid ester is 1% or more and less than 100%, and the amount of a glycerin fatty acid ester (triester) having three fatty acid ester groups is 50 mass % or less. The coating composition of the present disclosure can be suitably used for fruits and vegetables.

### Sugar-Based Surfactant

The sugar-based surfactant is a surfactant having, as a hydrophilic group, a sugar such as a monosaccharide, a disaccharide, a trisaccharide, a tetrasaccharide, a polysaccharide, a sugar alcohol, or another oligosaccharide, and examples of the sugar-based surfactant include a sugar fatty acid ester formed by ester bonding of a sugar and a fatty acid, and an alkyl glycoside formed by glycoside bonding of a sugar and a higher alcohol, and among these, a sugar fatty acid ester is preferable from the viewpoint of film formability.

The sugar-based surfactant preferably has crystallinity from the viewpoint of suppressing stickiness of the obtained coating film and increasing the water vapor barrier property and the oxygen barrier property.

From the viewpoint of suppressing stickiness of the obtained coating film, the sugar-based surfactant preferably contains a component that is solid at normal temperature (from 20 to 25° C.) in an amount of 60 mass % or more, preferably 70 mass % or more, preferably 80 mass % or more, and preferably 90 mass % or more. The sugar-based surfactant may be composed only of a component that is solid at normal temperature (from 20 to 25° C.), and therefore the proportion of the component thereof may be 100 mass % or less.

The HLB of the sugar-based surfactant is not particularly limited, but from the viewpoint of being able to form a coating film using an aqueous solvent described below, the HLB thereof is preferably 5 or more, preferably 7 or more, and preferably 9 or more. The upper limit of the HLB is usually 20, and is more preferably 18 or less.

### Sugar Fatty Acid Ester

The sugar-based surfactant of the present disclosure may contain a sugar fatty acid ester.

The sugar fatty acid ester is a compound in which a sugar and a fatty acid are ester-bonded.

The sugar in the sugar fatty acid ester may be any of a monosaccharide, a disaccharide, a trisaccharide, a tetrasaccharide, a polysaccharide, a sugar alcohol, and other oligosaccharides.

Examples of the monosaccharide include pentoses such as ribulose, xylulose, ribose, arabinose, xylose, lyxose, and deoxyribose; and hexoses such as psicose, fructose, sorbose, tagatose, allose, altrose, glucose, mannose, gulose, idose, galactose, talose, fucose, fuculose, and rhamnose.

The fatty acid constituting the sugar fatty acid ester may be the same as the constituent fatty acid of a sucrose fatty acid ester described below.

All constituent fatty acids of the sugar fatty acid ester need not be the same, and it is sufficient that 60 mass % or more of the constituent fatty acids in the sugar fatty acid ester be a suitable constituent fatty acid described below. From the viewpoint of suppressing stickiness of the resulting coating film, this proportion is preferably 70 mass % or more, preferably 80 mass % or more, and preferably 90 mass % or more. The upper limit thereof is not particularly limited, and need only be 100 mass % or less.

The constituent fatty acid composition of the sugar fatty acid ester can be measured by isolating the sugar fatty acid ester from the coating composition, forming a derivative therefrom, and then analyzing the derivative by gas chromatography.

The range of the number of fatty acid ester groups of the sugar fatty acid ester varies depending on the number of hydroxyl groups that can form an ester bond in the molecular structure of the sugar serving as the hydrophilic group, and is, for example, from 1 to 8 in the case of a sucrose fatty acid ester and from 1 to 4 in the case of a sorbitan fatty acid ester.

From the viewpoint of being dispersible or soluble in an aqueous solvent, the content of a sugar fatty acid ester (monoester, diester, or triester) having three or less fatty acid ester groups is preferably 50 mass % or more, preferably 60 mass % or more, and preferably 70 mass % or more, per 100 mass % of the total amount of the sugar-based surfactant. The upper limit thereof is not particularly limited, and need only be 100 mass % or less.

From the same viewpoint, the content of a sugar fatty acid ester (hexaester, heptaester, octaester, or higher ester) having six or more fatty acid ester groups is preferably 30 mass % or less, preferably 20 mass % or less, and preferably 10 mass % or less, per 100 mass % of the total amount of the sugar-based surfactant. A sugar fatty acid ester having 6 or more fatty acid ester groups need not be contained, and the content thereof may be 0 mass % or more.

The content for each number of fatty acid ester groups can be measured by the same method as the measurement method described in the below-described sucrose fatty acid ester section.

The sugar fatty acid ester is not particularly limited as long as it can be used in food, and examples thereof include sucrose fatty acid esters, sorbitan fatty acid esters, and glucose esters, and among these, sucrose fatty acid esters are preferable from the viewpoint of easy availability.

A single type of the sugar-based surfactant may be used alone, or two or more types thereof may be used in combination. In a case in which two or more types are used in combination, when the total amount of the sugar-based surfactant is 100 mass %, 60 mass % or more thereof is preferably a sucrose fatty acid ester. This proportion is preferably 70 mass % or more, preferably 80 mass % or more, and preferably 90 mass % or more, from the viewpoints of suppressing stickiness of the resulting coating film and increasing the water vapor barrier property and oxygen barrier property. As the sugar-based surfactant, a sucrose fatty acid ester may be used alone, and therefore the proportion thereof may be 100 mass % or less.

### Sucrose Fatty Acid Ester

A known sucrose fatty acid ester can be used as the sucrose fatty acid ester in the present composition, and it is sufficient that at least one of the eight hydroxyl groups of sucrose forms an ester structure with a fatty acid.

The constituent fatty acid of the sucrose fatty acid ester is preferably an edible oil or fat.

The number of carbons of the constituent fatty acid of the sucrose fatty acid ester is not particularly limited, but is preferably 12 or more and 22 or less, preferably 12 or more and 18 or less, and preferably 14 or more and 18 or less. When the number of carbons is within the above range, stickiness of the resulting coating film can be suppressed.

The constituent fatty acid of the sucrose fatty acid ester may be a saturated or unsaturated fatty acid, but is preferably a saturated fatty acid from the viewpoints of easily forming a solid at normal temperature (from 20 to 25° C.) and suppressing the stickiness of the obtained coating film.

More specific examples include lauric acid, myristic acid, pentadecylic acid, palmitic acid, palmitoleic acid, margaric acid, stearic acid, and oleic acid. Among these, lauric acid, myristic acid, palmitic acid, and stearic acid, which are saturated fatty acids having 12 or more and 18 or less carbons, are preferable, and myristic acid, palmitic acid, and stearic acid, which are saturated fatty acids having 14 or more and 18 or less carbons, are more preferable. One type of these saturated fatty acids may be used alone, or two or more types thereof may be used in combination.

It is not necessary that all the constituent fatty acids of the sugar fatty acid ester be the same, and it is sufficient that 60 mass % or more of the constituent fatty acids in the sucrose fatty acid ester be the above-mentioned suitable constituent fatty acids. From the viewpoint of suppressing stickiness of the resulting coating film, this proportion is preferably 70 mass % or more, preferably 80 mass % or more, and preferably 90 mass % or more. The upper limit thereof is not particularly limited, and need only be 100 mass % or less.

The constituent fatty acid composition of the sucrose fatty acid ester can be measured by isolating the sucrose fatty acid ester from the coating composition, forming a derivative therefrom, and then analyzing the derivative by gas chromatography.

The number of fatty acid ester groups in the sucrose fatty acid ester is from 1 to 8.

From the viewpoint of being able to form a coating film using an aqueous solvent, the content of a sucrose fatty acid ester (monoester, diester, or triester) having three or less fatty acid ester groups is preferably 50 mass % or more, preferably 60 mass % or more, and preferably 70 mass % or more, per 100 mass % of the total amount of the sucrose fatty acid ester. The upper limit thereof is not particularly limited, and need only be 100 mass % or less.

From the same viewpoint, the content of a sugar fatty acid ester (hexaester, heptaester, octaester, or higher ester) having 6 or more fatty acid ester groups is preferably 30 mass % or less, preferably 20 mass % or less, and preferably 10 mass % or less, per 100 mass % of the total amount of the sucrose fatty acid ester. A sucrose fatty acid ester having 6 or more fatty acid ester groups need not be contained, and the content thereof may be 0 mass % or more.

After the sugar fatty acid ester has been isolated from the composition, the content of each number of fatty acid ester groups can be measured in accordance with the method of assay described in Residue Monograph prepared by the meeting of the Joint FAO/WHO Expert Committee on Food Additives (JECFA), 84th meeting 2017 “Sucrose Esters of Fatty Acids” and Prepared at the 71st JECFA (2009) and published in FAO JECFA Monographs 7 (2009) “Sucrose Oligoesters Type I” and “Sucrose Oligoesters Type II”.

### Measurement of Monoesters to Triesters and Tetraesters or Higher Esters

A sample is dissolved in a certain amount of tetrahydrofuran (stabilizer-containing GPC or industrial grade), after which insoluble matter is removed using a 0.5 μm membrane filter, and the solution thereby obtained is used as a measurement sample and subjected to high-performance liquid chromatography under the following conditions. The compositional ratio is obtained by individually calculating the peak area of each of the monoesters to triesters and the combined peak area of the tetraesters or higher esters, and the ratio to the total peak area of all the peaks detected up to 43 minutes is calculated.

The peak area corresponds to an area from the start point (rising position) to the end point (falling position) of each peak.

When two or more peaks are adjacent to each other and the start point and the end point therebetween are unclear, the area is calculated by using, as the start point and the end point, the point at which the data between the peaks is the smallest.

### Measurement Conditions: Monoesters to Triesters and Tetraesters or Higher Esters

Apparatus: HLC-8320 GPC detector: differential refractometer (available from Tosoh Corporation)
Column: TSKgel G1000HXL, G2000HXL, G3000HXL, G4000HXL (available from Tosoh Corporation)
Column temperature: 40° C.
Detector temperature: 40° C.
Eluent: Tetrahydrofuran (stabilizer-containing GPC or industrial grade)
Flow rate: 0.8 ml/min
Injection amount: 80 μl
Measurement time: 50 minutes (area ratio is calculated based on all peaks detected up to 43 minutes)

### Measurement of Tetraesters to Octaesters

A sample is dissolved in a certain amount of a mixture of methanol (special grade reagent) and tetrahydrofuran (stabilizer-free HPLC grade) having a ratio of methanol to tetrahydrofuran of 20/80 (vol/vol), after which insoluble matter is removed using a 0.45 μm membrane filter, and the solution thereby obtained is used as a measurement sample and is subjected to high-performance liquid chromatography under the following conditions. The compositional ratio of the tetraesters to octaesters is calculated by individually calculating the peak area of each of the tetraesters to octaesters, calculating the ratio to the total peak area of the tetraesters to octaesters, and then proportionally dividing the area ratio of the tetraesters and higher esters obtained in the above “Measurement of Monoesters to Triesters and Tetraesters or Higher Esters” section by the area ratio of the tetraesters to octaesters.

The peak area corresponds to an area from the start point (rising position) to the end point (falling position) of each peak.

When two or more peaks are adjacent to each other and the start point and the end point therebetween are unclear, the area is calculated by using, as the start point and the end point, the point at which the data between the peaks is the smallest.
Measurement Conditions: Tetraesters to Octaesters
Apparatuses
Degasser: DGU-20A (available from Shimadzu Corporation)
Pump: LC-20AD (available from Shimadzu Corporation)
Oven: CTO-20A (available from Shimadzu Corporation)
Detector: RID-20A differential refractometer (available from Shimadzu Corporation)
Column: 150 mm×4.6 mm i.d.; ODS-2 (available from GL Sciences Inc.)
Column temperature: 40° C.
Detector temperature: 40° C.
Eluent: Methanol (special grade reagent)/tetrahydrofuran (stabilizer-free HPLC grade)=70/30 to 50/50 (vol/vol)
Flow rate: 0.8 ml/min
Injection amount: 20 μl
Measurement time: 16 minutes

Examples of commercially available products of the sucrose fatty acid ester include “Ryoto (registered trademark) Sugar Ester S-370”, “Ryoto Sugar Ester S-570”, “Ryoto Sugar Ester S-970”, “Ryoto Sugar Ester S-1170”, “Ryoto Sugar Ester S-1570”, “Ryoto Sugar Ester S-1670”, “Ryoto Sugar Ester P-170”, “Ryoto Sugar Ester P-1670”, “Ryoto Sugar Ester M-1695”, “Ryoto Sugar Ester 0-170”, “Ryoto Sugar Ester 0-1570”, “Ryoto Sugar Ester L-195”, “Ryoto Sugar Ester L-595”, “Ryoto Sugar Ester L-1695”, “Ryoto Sugar Ester B-370”, “Ryoto Sugar Ester ER-190”, and “Ryoto Sugar Ester POS-135” (the above are available from Mitsubishi Chemical Corporation), and “DK Ester (registered trademark) F-160”, “DK Ester F-140”, “DK Ester F-110”, “DK Ester F-70”, and “DK Ester F-50” (the above are available from DKS Co., Ltd.).

Among these, from the viewpoint of industrially using the coating composition of the present disclosure, a sucrose fatty acid ester that is solid at 0° C. or higher is preferably used because the application range can be widened.

A single sucrose fatty acid ester may be used alone, or two or more types may be used in combination.

The sucrose fatty acid ester preferably has crystallinity from the viewpoint of suppressing stickiness of the obtained coating film and increasing the water vapor barrier property and the oxygen barrier property.

From the viewpoint of suppressing stickiness of the obtained coating film, the sucrose fatty acid ester preferably contains a component that is solid at normal temperature (from 20 to 25° C.) in an amount of 60 mass % or more, preferably 70 mass % or more, preferably 80 mass % or more, and preferably 90 mass % or more. The sucrose fatty acid ester may be composed only of a component that is solid at normal temperature (from 20 to 25° C.), and therefore the proportion of the component thereof may be 100 mass % or less.

The sucrose fatty acid ester preferably has crystallinity from the viewpoint of suppressing stickiness of the obtained coating film and increasing the water vapor barrier property.

The crystal melting peak temperature is preferably 40° C. or higher and 80° C. or lower, and preferably 45° C. or higher and 70° C. or lower. Stickiness of the resulting coating film can be suppressed by setting the crystal melting peak temperature to 40° C. or higher. Meanwhile, when the crystal melting peak temperature is 80° C. or lower, heating can be reduced when dissolving in an aqueous solvent, and productivity becomes favorable.

The crystal melting peak temperature is the temperature at which a crystal melting peak is detected in differential scanning calorimetry (DSC), and is measured by placing 1 mg of a sucrose fatty acid ester in an aluminum pan, and initially heating the material from 30° C. to 100° C. at a temperature increase rate of 10° C./min. When a plurality of crystal melting peaks exists, the total sum of the peak areas in the above temperature range is preferably 50% or more of the total sum of the peak areas in the entire temperature range.

### Additional Fatty Acid Ester

The present composition may contain an additional fatty acid ester as long as the effects of the present disclosure are not impaired. The additional fatty acid ester is not particularly limited as long as it can be used in food, and examples thereof include sorbitan fatty acid esters and glucose esters.

### Glycerin Fatty Acid Ester

The glycerin fatty acid ester is a compound in which glycerin and a fatty acid are ester-bonded.

Examples of the fatty acid constituting the glycerin fatty acid ester include the same fatty acids as those constituting the sucrose fatty acid ester.

From the viewpoints of dispersibility in an aqueous solvent, viscosity of the composition, and handling ease, the content of the glycerin fatty acid ester (monoester) having one fatty acid ester group is usually 5 mass % or more per 100 mass % of the total amount of the glycerin fatty acid ester. The content thereof is preferably 10 mass % or more, preferably 20 mass % or more, preferably 30 mass % or more, and preferably 40 mass % or more. In this range, the content is preferably 50 mass % or more, preferably 60 mass % or more, preferably 70 mass % or more, and preferably 80 mass % or more. The upper limit thereof is not particularly limited, and need only be 100 mass % or less.

The content of the glycerin fatty acid ester (diester) having two fatty acid ester groups depends on the content of monoesters and triesters, and is not particularly limited.

From the viewpoints of dispersibility in an aqueous solvent, viscosity of the composition, and handling ease, the content of the glycerin fatty acid ester (triester) having three fatty acid ester groups is preferably 50 mass % or less, preferably 40 mass % or more, preferably 30 mass % or more, preferably 20 mass % or more, and preferably 10 mass % or more, per 100 mass % of the total amount of the glycerin fatty acid ester. The lower limit thereof is not particularly limited, and a glycerin fatty acid ester (triester) having three fatty acid ester groups need not be contained (0 mass %), or as an impurity, a glycerin fatty acid ester (triester) having three fatty acid ester groups may be contained in an amount of less than 1 mass %, or in an amount of 0.5 mass % or more.

From the viewpoints of dispersibility in an aqueous solvent, viscosity of the composition, and handling ease, the total content of the glycerin fatty acid ester (monoester) having one fatty acid ester group and the fatty acid ester (diester) having two fatty acid ester groups is preferably 50 mass % or more, preferably 60 mass % or more, and preferably 70 mass % or more, per 100 mass % of the total amount of the glycerin fatty acid ester. The upper limit thereof is not particularly limited, and need only be 100 mass % or less.

Among this range, the proportion of monoesters when the monoesters and the diesters are totaled is preferably 20 mass % or more, preferably 40 mass % or more, preferably 50 mass % or more, preferably 60 mass % or more, and 80 mass %. The upper limit thereof is not particularly limited, and need only be 100 mass % or less.

The type and amount of the fatty acid can be analyzed by column chromatography, gas chromatography, thin-layer chromatography, high-performance liquid chromatography, colorimetric analysis, or the like.

### Mass Ratio

The mass ratio (solid content) of the sucrose fatty acid ester to the total mass of the sucrose fatty acid ester and the glycerin fatty acid ester is preferably 1% or more, preferably 5% or more, preferably 10% or more, and preferably 20% or more. The ratio thereof is also less than 100%. When the mass ratio is within this range, the coatability of the present composition is favorable, and the coating appearance after application to fruits and vegetables is good. From the above viewpoints, the mass ratio of the sucrose fatty acid ester to the glycerin fatty acid ester is preferably from 1/99 to 99/1, preferably from 5/95 to 99/1, preferably from 10/90 to 98/2, preferably in a range from 20/80 to 97/3, and preferably in a range from 20/80 to 80/20.

### Aqueous Solvent

The present composition may be solvent-free, but from the viewpoint of coating efficiency, the present composition preferably contains a solvent. As the solvent, an aqueous solvent is preferably contained. The aqueous solvent constituting the coating composition may be water or a mixed solvent of water and one or more water-soluble organic solvents. Examples of the water-soluble organic solvent include alcohols such as ethanol, isopropanol, ethylene glycol, and glycerin. From the viewpoint of enabling application to food, the formation of an aqueous composition in which water is used as a solvent is preferred, but from the viewpoints of stability and coatability, an organic solvent such as the above-mentioned alcohol may be contained as a solvent in addition to water.

The content of the organic solvent in the aqueous solvent is preferably 30 mass % or less, preferably 20 mass % or less, preferably 10 mass % or less, and preferably 5 mass % or less.

### Additional Component

The coating composition of the present disclosure may contain an additional component in an amount such that the function of the coating agent of the present disclosure is not impaired. Examples of the additional component include a pH adjuster.

As the pH adjuster, for example, acetic acid, lactic acid, citric acid, ammonia, or the like can be used.

### Differential Scanning Calorimetry at 0° C. or Higher

In differential scanning calorimetry of the coating composition according to the present disclosure, in a measurement temperature range of 0° C. or higher, the ratio of the total area A₁ of endothermic peaks in the temperature range of from 0° C. to 40° C. to the total area A₂ of endothermic peaks in the temperature range of from 0° C. to 80° C. may be 50% or less. The ratio thereof is preferably 40% or less, preferably 30% or less, and preferably 20% or less. The ratio thereof may be 0%. When the ratio thereof is within the above range, the proportion undergoing a phase change of the coating film formed from the coating composition is reduced within a practical temperature range for storing, transporting, and selling fruits and vegetables that are not stored in a frozen state, and phase changes that affect the properties of the coating film do not occur. For example, freshness-preserving functions such as the water vapor barrier property and oxygen barrier property described below can be maintained. The peak area is defined as an area from the start point (rising position) to the end point (falling position) of each peak.

The temperature range for calculating A₁ is preferably 0° C. or higher and 35° C. or lower, preferably 0° C. or higher and 30° C. or lower, and preferably 0° C. or higher and 25° C. or lower. This indicates that the temperature is within the above-described temperature range preferable for practical use.

When the measurement temperature range is set to 0° C. or higher, the characteristics of the coating film can be reflected in the temperature range practical for storing, transporting, and selling fruits and vegetables that are not stored in a frozen state. For example, for a compound having a melting point of less than 0° C., when the measurement temperature range is set to less than 0° C., measurements can be carried out that reflect the behavior of the phase change from a liquid to a solid and behaviors such as the crystallization of a component that is not crystallized and the melting of a solid. However, these behaviors are not exhibited within the practical temperature range described above, and it is difficult to say that the measurements reflect practical behaviors.

As for A₁ and A₂, there may be a case in which a plurality of peaks exists within the respective temperature ranges for calculating the total area, or a case in which only a portion of a peak falls within the temperature range. In such a case, all areas of all peaks that exist within the temperature range are calculated for only the portions that fall within the temperature range. For example, when one broad peak is present from 0 to 50° C., only the portion from 0 to 40° C. is calculated as A₁.

It is thought that the surfactant used in the coating composition of the present disclosure has almost no peak in a temperature range exceeding 80° C., and therefore it is considered that it is not necessary to take into account the range exceeding 80° C. for A₂.

Differential scanning calorimetry with a measurement temperature range of 0° C. or higher is carried out under the following conditions: Measurement apparatus: differential scanning calorimeter
Measurement method: heat flux method
Temperature: 25° C.→0° C.→100° C.
Temperature increase and decrease rate: 10° C./min
Atmosphere: nitrogen
Sample preparation: The coating composition is placed in an empty aluminum pan so that the dry solid content becomes 1 mg, and the material is left to stand at room temperature to dry. A change in weight of 1% or less from the previous day is confirmed, and a measurement sample is obtained.
Reference: aluminum pan

In a case of a sample in which no peak is observed when heating and cooling at a temperature lower than 0° C., the temperature may be decreased from 25° C. to a temperature lower than 0° C. and then increased to 100° C. for measurements.

### Differential Scanning Calorimetry at −80° C. or Higher

In differential scanning calorimetry of the coating composition according to the present disclosure in a measurement temperature range of −80° C. or higher, the ratio of the total exothermic peak area A₃ to the total endothermic peak area A₂ in the temperature range of 0° C. or higher and 80° C. or lower may be 50% or less. When the temperature is within the above range, stickiness of the coating film formed from the coating composition and in the temperature range in which fruits and vegetables not stored in a frozen state are stored, transported, and sold is suppressed, and thus the handling properties are improved, and furthermore, freshness-preserving functions such as the water vapor barrier property and the oxygen barrier property described below can be improved. The peak area is defined as the area from the start point (rising position) to the end point (falling position) of each peak.

The exothermic peak is considered to indicate a behavior of a phase change in which a component that has not become a solid becomes a solid, or a behavior in which a component that has not crystallized crystallizes. Meanwhile, an endothermic peak observed at 0° C. or higher is considered to be a peak resulting from the behavior of a phase change in which all components that are capable of becoming a solid in the coating film formed from the coating composition become a solid, such as, for example, a behavior of melting of a crystallized product obtained by crystallizing all the components that are capable of being crystallized in the coating film. Therefore, it is considered that the ratio of the total exothermic peak area A₃ to the total endothermic peak area A₂ at temperatures 0° C. or higher and 80° C. or lower indicates the ratio of the components that have not been solidified at 0° C. or higher, for example, components that are not crystallized, in the coating film formed from the coating composition. From the viewpoint of enhancing the above effect, this ratio is preferably 40% or less, preferably 30% or less, and preferably 20% or less. Some exothermic peaks observed by the measurement method described below may be observed during heating. This is considered to indicate a behavior of components that are in a supercooled state becoming a solid, such as, for example, becoming crystallized.

As for A₂ and A₃, there may be a case in which a plurality of peaks is present in each temperature range in which the total area is calculated. In such a case, all areas of all peaks that exist within the temperature range are calculated for only the portions that fall within the temperature range. Although unlikely, there is also a possibility that one peak is present in a temperature range that includes 0° C. In such a case, whether the peak area is a part or all of A₂ and A₃ is determined according to whether the peak is an endothermic peak or an exothermic peak. For the surfactant used in the coating composition of the present disclosure, it is thought that there are almost no peaks present in the temperature ranges below −80° C. and above 80° C., and therefore it is thought that there is no need to consider the ranges below −80° C. and above 80° C. for A₂ and A₃.

The differential scanning calorimetry in a measurement temperature range of −80° C. or higher is carried out under the following conditions:
Measurement apparatus: differential scanning calorimeter
Measurement method: heat flux method
Temperature: 25° C.→−80° C.→100° C.
Temperature increase and decrease rate: 10° C./min
Atmosphere: nitrogen
Sample preparation: The coating composition is placed in an empty aluminum pan so that the dry solid content becomes 1 mg, and the material is left to stand at room temperature to dry. A change in weight of 1% or less from the previous day is confirmed, and a measurement sample is obtained.
Reference: aluminum pan

### Viscosity

The shear viscosity of the present composition at a shear rate of 1 s⁻¹ is preferably 8000 mPa·s or less. The shear viscosity is preferably 4000 mPa·s or less, preferably 2000 mPa·s or less, preferably 1000 mPa·s or less, and most preferably 500 mPa·s or less. When the shear viscosity is equal to or less than the upper limit value, the present composition can be uniformly applied. The lower limit of the shear viscosity is preferably 0.1 mPa·s or more. The lower limit thereof is preferably 1 mPa·s or more, preferably 5 mPa·s or more, preferably 10 mPa·s or more, and preferably 50 mPa·s or more. Even among these, the lower limit is preferably 80 mPa·s or more, and is preferably 100 mPa·s or more. When the shear viscosity is equal to or more than the above lower limit value, dripping can be prevented and the appearance can be improved when the present composition is applied, and in addition, a film thickness equal to or more than a certain thickness is easily secured, and the storage stability of fruits and vegetables can be favorably maintained.

### Viscosity Measurement Conditions

Apparatus: rotational rheometer (model: Kinexus Pro+)
Plate: cone plate type, diameter of 40 mm, cone angle of 2 degrees
Measurement temperature: 25° C.
Shear rate history and measurement range: shear viscosity at shear rate of 1 (s⁻¹) when the shear rate is increased from 0 to 1000 (s⁻¹) and then returned to 0 (s⁻¹)

### Concentration of Nonvolatile Component

The concentration of a nonvolatile component in the present composition is not particularly limited, but is usually 0.1 mass % or more. The concentration is preferably 0.2 mass % or more, preferably 0.3 mass % or more, preferably 0.5 mass % or more, preferably 1 mass % or more, and preferably 2 mass % or more. The concentration is preferably 2.5 mass % or more, preferably 3.0 mass % or more, preferably 3.5 mass % or more, and preferably 4.0 mass % or more. In particular, when the concentration is 1 mass % or more, a sufficient film thickness can be ensured when a coating film is formed, and therefore, the barrier properties against gases such as water vapor and oxygen are easily manifested, and the storage stability of fruits and vegetables can be sufficiently exhibited.

The upper limit of the nonvolatile component concentration in the present composition is not particularly limited, but is usually 60 mass % or less. The upper limit thereof is preferably 50 mass % or less, preferably 40 mass % or less, preferably 30 mass % or less, preferably 20 mass % or less, and preferably 10 mass % or less. By setting the nonvolatile component concentration to within the above-described range, a coating film having a suitable film thickness is easily formed while appropriately dissolving or dispersing the sucrose fatty acid ester and the glycerin fatty acid ester in the aqueous solvent. As a result, the appearance of fruits and vegetables on which the coating film is formed is improved, and the storage stability can be increased.

The “nonvolatile component concentration” in the present disclosure is the concentration of nonvolatile components excluding the solvent contained in the composition.

### pH of Present Composition

From the viewpoint of safe application to food, the pH of the present composition is preferably 4 or higher and 10 or lower, and preferably 4 or higher and 8 or lower.

### Method for Producing Coating Composition

The coating composition of the present disclosure is preferably produced by mixing the sugar-based surfactant, the glycerin fatty acid ester, and the solvent, heating the mixture, and then cooling the mixture. This method is considered to increase the uniformity of the mixed state of the sugar-based surfactant and glycerin fatty acid ester in aggregates formed from the sugar-based surfactant and the glycerin fatty acid ester, and thereby a dense film is formed, and gas permeability can be further reduced.

In addition to the above-described production method, the uniformity of the coating composition can be enhanced by using a composition in which a sugar fatty acid ester and a glycerin fatty acid ester are used in combination.

### Fruit or Vegetable Having Coating Film

The fruit or vegetable having a coating film of the present disclosure is a fruit or vegetable that is coated with the above-described coating composition to form a coating film. Through the coating film, respiration and moisture transpiration of the fruit or vegetable are suppressed, and the freshness of the fruit or vegetable is preserved.

### Fruit or Vegetable

Examples of the fruit or vegetable to which the present composition is applied include vegetables and fruits, and specific examples include citrus fruits such as oranges, grapefruits, and mandarin oranges; pome fruits such as quince, Asian pears, loquat, and apples; stone fruits such as peaches, apricots, plums, Japanese plums, and yellow peaches; small fruits such as berries including blackberries, raspberries, blueberries, and grapes; root vegetables such as daikon radishes, carrots, ginger, and burdock; tubers such as sweet potatoes, taro, and potatoes; bulbs such as onions, chives, garlic, shallots, and leeks; gourds such as cucumbers, zucchini, bitter melon, pumpkin, melon, and watermelon; nightshades such as tomatoes, cherry tomatoes, eggplants, bell peppers, and chili peppers; Brassica vegetables such as broccoli, cauliflower, and Szechuan pickles; leafy vegetables such as bok choy, mustard greens, cabbage, Chinese cabbage, lettuce, and chrysanthemum; stem vegetables such as giant butterbur, asparagus, bracken, and fern, and mushrooms such as shiitake mushrooms, king oyster mushrooms, beech mushrooms, enoki mushrooms, and hen-of-the-woods mushrooms.

### Coating Film

The coating film in the present disclosure is obtained by volatilizing the solvent from the present composition, and therefore the types and compositional proportions of the sugar-based surfactant and glycerin fatty acid ester in the coating film and the suitable concentration of the nonvolatile component are the same as those described above.

From the viewpoint of maintaining the freshness of fruits and vegetables, the coating film in the present disclosure preferably has a water vapor barrier property and/or an oxygen barrier property in order to suppress respiration and the transpiration of moisture. From the viewpoint of safety when the coating film is used for food, the coating film is preferably edible.

### Water Vapor Barrier Property

The water vapor transmission rate at 30° C. and 80% RH per 1 μm of the coating film formed from the coating composition of the present disclosure is preferably 0.1 g/(m²·day·atm) or more, preferably 0.5 g/(m²·day·atm) or more, and preferably 1.0 g/(m²·day·atm) or more. The water vapor transmission rate thereof is preferably 100 g/(m²·day·atm) or less, preferably 80 g/(m²·day·atm) or less, preferably 60 g/(m²·day·atm) or less, and preferably 40 g/(m²·day·atm) or less. Even amongst these ranges, the water vapor transmission rate is preferably 20 g/(m²·day·atm) or less, preferably 17 g/(m²·day·atm) or less, and preferably 15 g/(m²·day·atm) or less. When the water vapor transmission rate is within the above range, transpiration from vegetables or fruits can be suppressed, and freshness can be maintained.

The water vapor transmission rate (WVTR) can be measured by a differential pressure method using the water vapor transmission rate measuring apparatus DELTAPERM in accordance with JIS K7129-5. More specifically, the water vapor transmission rate is a value obtained by measuring the water vapor transmission rate when a polyethylene terephthalate film having a thickness of 50 μm is coated with the coating composition under conditions of 30° C. and 80% RH, and then converting the measured value thereof into a transmission rate per 1 μm by the following equation.

$$W V T R per 1 μ m of coating film = \frac{( Coating film thickness ( μ m ) )}{( \frac{1}{( \begin{matrix}W V T R of P E T film \\ with coating film\end{matrix} )} - \frac{1}{( W V T R of P E T film )} )} \qquad [ Math . 1 ]$$

### Oxygen Barrier Property

The oxygen transmission rate at 25° C. and 50% RH per 1 μm of the coating film formed from the coating composition of the present disclosure is preferably 0.1 cc/(m²·day·atm) or more, preferably 0.5 cc/(m²·day·atm) or more, and preferably 1.0 cc/(m²·day·atm) or more. The oxygen transmission rate thereof is preferably 500 cc/(m²·day·atm) or less, preferably 300 cc/(m²·day·atm) or less, preferably 250 cc/(m²·day·atm) or less, and preferably 200 cc/(m²·day·atm) or less. Even amongst these ranges, the oxygen transmission rate is preferably 100 cc/(m²·day·atm) or less, preferably 90 cc/(m²·day·atm) or less, and preferably 50 cc/(m²·day·atm) or less.

When the oxygen transmission rate is within the above range, aging of vegetables or fruits due to respiration can be suppressed, and freshness can be further maintained.

The oxygen transmission rate (OTR) can be measured by an isobaric method using the oxygen transmission rate measuring apparatus OX-TRAN 2/21 (available from MOCON, Inc.) in accordance with JIS K7126-2. More specifically, the oxygen transmission rate is a value obtained by measuring the oxygen transmission rate when a polyethylene terephthalate film having a thickness of 50 μm is coated with the coating composition under conditions of 25° C. and 50% RH, and then converting the measured value thereof into a transmission rate per 1 μm by the following equation.

$$O T R per 1 μ m of coating film = \frac{( Coating film thickness ( μ m ) )}{( \frac{1}{( \begin{matrix}O T R of P E T film \\ with coating film\end{matrix} )} - \frac{1}{( O T R of P E T film )} )} \qquad [ Math . 2 ]$$

### Edibility

The term “edible” means that the coating film can be used on food. From the viewpoint of safety, it is preferable to use a compound approved as a food additive in an amount that satisfies the approval thereof, thereby making the coating film edible.

### Crystallinity

The coating film of the present disclosure preferably has crystallinity from the viewpoint of suppressing stickiness and increasing the water vapor barrier property.

The crystal melting peak temperature of the coating film of the present disclosure is preferably 40° C. or higher and 80° C. or lower, and more preferably 45° C. or higher and 70° C. or lower. Stickiness of the resulting coating film can be suppressed by setting the crystal melting peak temperature to 40° C. or higher.

The crystal melting peak temperature is the temperature at which a crystal melting peak is detected when the temperature is initially increased from 30° C. to 100° C. in differential scanning calorimetry (DSC) with measurements carried out at a heating rate of 10° C./min. When a plurality of crystal melting peaks exists, the total sum of the peak areas in the above temperature range is preferably 50% or more of the total sum of the peak areas in the entire temperature range. In the measurements, the coating film may be formed on any base material and then measured, or the coating film may be measured alone. Examples of the base material include a polyethylene terephthalate film and a glass plate.

### Average Film Thickness

The average film thickness of a coating film of the fruit or vegetable having the coating film is preferably 0.1 μm or more and 10 μm or less, and preferably 0.5 m or more and 5 μm or less. When the average film thickness is 0.1 μm or more, respiration and moisture transpiration of the fruit or vegetable are sufficiently suppressed. Meanwhile, when the average film thickness is 10 μm or less, the coating film can be formed in a state in which the texture of the fruit or vegetable as a food product is maintained.

In the present disclosure, the thickness of the coating film need not be uniform over the entire food.

The average film thickness of the coating film can be determined by observing a cross section of the fruit or vegetable having the coating film with a microscope, measuring the thickness at 10 or more randomly selected points, and obtaining an average value from the 10 measurements.

### Method for Preserving Freshness of Fruit or Vegetable

The method for preserving the freshness of a fruit or vegetable of the present disclosure includes a step of covering the fruit or vegetable with the present composition.

The step of covering with the present composition is not particularly limited as long as it is a step of covering a fruit or vegetable with the present composition, and examples thereof include a direct application method such as brush application or curtain coating; an immersion method such as impregnation coating; and a spraying method such as spray coating.

Among these, an immersion method or a spraying method is preferable from the viewpoints of productivity and being able to relatively uniformly coat a fruit or vegetable having a three-dimensional shape.

When a fruit or vegetable is to be covered with the present composition, the present composition may be applied to only a portion of the fruit or vegetable, or to the entirety thereof. By applying the present composition to the entire fruit or vegetable, the freshness of the fruit or vegetable can be effectively maintained. Meanwhile, from the viewpoints of shortening the drying time of the present composition and increasing the efficiency of the film forming process, the present composition is preferably applied to a portion of the fruit or vegetable.

In this case, the application area in relation to the surface area of the fruit or vegetable is preferably 10% or more, preferably 25% or more, preferably 40% or more, and still preferably 50% or more.

Moreover, a portion of the applied present composition may be removed. The removal method is not particularly limited, and examples thereof include removal by wind pressure using an air dryer. Through such removal, poor drying of portions where an excessive amount of the coating composition has been applied can be prevented.

An example of the application method is described in “Coating Methods” written by Yuji Harazaki and published by Maki Shoten in 1979.

After the present composition is applied to a fruit or vegetable, the coating film may be dried for the purpose of removing the aqueous solvent or the like. Examples of the drying method include static drying, air drying, and heat drying, and from the viewpoint of preserving the freshness of a fruit or vegetable, a method of drying by leaving the coating film standing at room temperature (from 20 to 25° C.) or a method of air drying at room temperature is preferable.

### EXAMPLES

Next, the present disclosure will be described in more detail with reference to examples. However, the present disclosure is not limited to the examples described below.

### Evaluation Method

### 1. Coating Liquid (Coating Composition)

### State of Coating Liquid

As an evaluation of the stability of a coating liquid, the state of the coating liquid was evaluated according to the following criteria.

### Evaluation Criteria

A: The liquid is uniform and exhibits fluidity.
B: The liquid is uniform but does not exhibit fluidity.
C: The liquid is non-uniform, and precipitation or separation is observed.

### Viscosity of Coating Liquid

The change in shear rate in terms of the shear viscosity of the liquids prepared in each of the Examples and Comparative Examples was measured under the following conditions, and the shear viscosity at the shear rate of 1 s⁻¹ was defined as the viscosity of the coating liquid.

### Viscosity Measurement Conditions

Apparatus: rotational rheometer (model: Kinexus Pro+)
Plate: cone plate type, diameter of 40 mm, cone angle of 2 degrees
Measurement temperature: 25° C.
Shear rate history and measurement range: shear viscosity at shear rate of 1 (s⁻¹) when the shear rate was increased from 0 to 1000 (s⁻¹) and then returned to 0 (s⁻¹)

### State of Coating Film

### Differential Scanning Calorimetry at 0° C. or Higher

Differential scanning calorimetry was carried out under the following conditions. When no peak is observed at temperatures lower than 0° C., the temperature may be changed from 25° C. to −80° C. and then to 100° C.
Measurement apparatus: NETZSCH DSC 204F1
Measurement method: heat flux method
Temperature: 25° C.→0° C.→100° C.
Temperature increase and decrease rate: 10° C./min
Atmosphere: nitrogen
Sample preparation: The coating composition was placed in an empty aluminum pan so that the dry solid content was 1 mg, and the material was left to stand at room temperature to dry. A change in weight of 1% or less from the previous day was confirmed, and a measurement sample was obtained.
Reference: aluminum pan

### Differential Scanning Calorimetry at −80° C. or Higher

Differential scanning calorimetry in a measurement temperature range of −80° C. or higher was carried out under the following conditions:
Measurement apparatus: NETZSCH DSC 204F1
Measurement method: heat flux method
Temperature: 25° C.→−80° C.→100° C.
Temperature increase and decrease rate: 10° C./min
Atmosphere: nitrogen
Sample preparation: The coating composition was placed in an empty aluminum pan so that the dry solid content was 1 mg, and the material was left to stand at room temperature to dry. A change in weight of 1% or less from the previous day was confirmed, and a measurement sample was obtained.
Reference: aluminum pan

### 2. Evaluation of Freshness Preservation

Avocados were used as a fruit or vegetable product, coating liquids prepared in the respective Examples and Comparative Examples were applied thereto by a dipping method, and the coating appearance, the weight retention rate, and the exocarp color were evaluated.

### Coating Appearance

The coating liquid prepared in each of the Examples and Comparative Examples was applied to the avocados by a dipping method, and appearance defects due to the coating liquid remaining on the exocarp of the avocado after drying were visually evaluated according to the following criteria.

### Evaluation Criteria

A: Portions of appearance defects accounted for less than 5% of the exocarp surface of the avocado.
B: Portions of appearance defects accounted for 5% or more and less than 50% of the exocarp surface of the avocado.
C: Portions of appearance defects accounted for 50% or more and 100% or less of the exocarp surface of the avocado.

### Weight Retention Rate

On the basis of the weight of the avocado before storage (day 0) and the weight of the avocado after storage at 25° C. and 50% RH for 3 days, 4 days, and 5 days, the weight retention rates after the storage for 3 days, 4 days, and 5 days ((weight after storage/weight on day 0)×100(%)) were determined.

### Weight Loss Rate

On the basis of the weight of the avocado before storage (day 0) and the weight of the avocado after storage at 25° C. and 50% RH for 4 days, the weight loss rate after the storage for 4 days (100−(weight after storage/weight on day 0)×100(%)) was determined.

### Exocarp Color

As avocados ripen, the color of the exocarp changes from green to dark purple. Since these changes are easily understood from avocados and consumers generally evaluate the freshness of avocados by color, a coating film was formed on the surface of avocados, and the freshness-preserving effect was confirmed by the change in color.

Five avocados were prepared for each Example and Comparative Example, and the change in color was evaluated according to the following criteria. According to the following criteria, the change in color was evaluated before storage (day 0) and after storage at 25° C. and 50% RH for 3 days, 4 days, and 5 days.

### Evaluation Criteria

A: The surfaces of none of the samples (0%) or less than 50% of the samples turned completely dark purple.
B: 50% or more and less than 100% of the samples turned completely dark purple on the surface.
C: The surfaces of all the samples (100%) turned completely dark purple.

### Fruit Hardness

A load (N) was measured when a cylindrical plunger having a diameter of 5 mm was pressed 3 mm into an avocado at a speed of 60 mm/min. Three avocados stored at 25° C. and 50% RH for 4 days were used to measure the fruit hardness. The measurements were taken at three different locations near the equator of each avocado, and the arithmetic mean of the obtained values was taken as the fruit hardness.

### Texture of Fruit Surface After Coating

Five avocados subjected to the coating treatment and prior to storage (0 day) were prepared, and the texture of the surface of the coated fruit was evaluated by hand according to the following criteria. The evaluation was based on the results of a consultation between three experienced evaluators.

### Evaluation Criteria

A: Either no samples (0%) felt sticky or less than 50% of the samples felt sticky.
B: 50% or more of the samples felt sticky, or stickiness was felt on the surface of all the samples (100%).

The raw materials that were used are as follows:
S-1170: Sucrose stearate, “Ryoto (registered trademark) Sugar Ester S-1170” available from Mitsubishi Chemical Corporation, HLB: approximately 11, monoester content: approximately 55%, bound fatty acid purity: approximately 70%
S-1670: Sucrose stearate, “Ryoto (registered trademark) Sugar Ester S-1670” available from Mitsubishi Chemical Corporation, HLB: approximately 16, monoester content: approximately 75%, bound fatty acid purity: approximately 70%
S-570: Sucrose stearate, “Ryoto (registered trademark) Sugar Ester S-570” available from Mitsubishi Chemical Corporation, HLB: approximately 5, monoester content: approximately 30%, bound fatty acid purity: approximately 70%
F-110: Sucrose stearate, “DK Ester (registered trademark) F-110” available from DKS Co., Ltd., HLB: 11
S-100P: Glycerin fatty acid ester, “RIKEMAL (registered trademark) S-100P” available from Riken Vitamin Co., Ltd., main component: glycerin monostearate, HLB: 4.3, melting point: 63 to 68° C., monoester content: 95% or more
M-100: Glycerin fatty acid ester, “POEM (registered trademark) M-100” available from Riken Vitamin Co., Ltd., main component: glycerin monocaprylate, HLB: 7.0, melting point: approximately 31° C., monoester content: 85% or more
M-1695: Sucrose myristate, “Ryoto (registered trademark) Sugar Ester M-1695” available from Mitsubishi Chemical Corporation, HLB: approximately 16, monoester content: approximately 80%, bound fatty acid purity: approximately 20%
MCT oil: Medium-chain fatty acid triacylglycerol (glyceryl tri(caprylate/caprate)) available from The Nisshin Oillio Group, Ltd.
Tannic acid: available from FUJIFILM Wako Pure Chemical Corporation

### Example 1 (Method for Preparing Coating Liquid)

A coating liquid (coating composition) was prepared by dispersing a glycerin fatty acid ester (S-100P) and a sucrose fatty acid ester (S-1170) in a water solvent (ion-exchanged water) at 73° C. for 30 minutes, and then allowing the dispersion to stand at a room temperature of 20° C. to cool the dispersion to 25° C. The content of each material is as shown in Table 1. The evaluation results are shown in Table 1.

### Examples 2 to 5

Coating liquids were prepared in the same manner as in Example 1 except that the content of the glycerin fatty acid ester and the content of the sucrose fatty acid ester were changed as shown in Table 1. The evaluation results are shown in Table 1.

### Comparative Example 1

A coating liquid was prepared in the same manner as in Example 1 except that RIKEMAL (registered trademark) S-100P was used as a glycerin fatty acid ester, and a sucrose fatty acid ester was not added. The coating liquid was separated from the solvent. Measurements failed to be obtained in the subsequent evaluations.

### Comparative Example 2

The above evaluations were carried out on avocados to which the coating liquid was not applied. The results are shown in Table 1.

TABLE 1

| Example | Example | Example | Example | Example | Comparative | Comparative |
|---|---|---|---|---|---|---|
| 1 | 2 | 3 | 4 | 5 | Example 1 | Example 2 |

Liquid composition

| | | | | | | | | |
|---|---|---|---|---|---|---|---|---|
| Solid content concentration | [mass %] | 5.00 | 5.00 | 5.00 | 5.00 | 5.00 | 5.00 | — |
| S-1170: Sugar fatty acid ester | [mass %] | 4.75 | 4.50 | 3.75 | 2.00 | 1.25 | 0.00 | — |
| S-100P: Glycerin fatty acid ester | [mass %] | 0.25 | 0.50 | 1.25 | 3.00 | 3.75 | 5.00 | — |
| Ion-exchanged water | [mass %] | 95.00 | 95.00 | 95.00 | 95.00 | 95.00 | 95.00 | — |

Mass ratio of sugar-based surfactant to glycerin fatty acid ester

| | | | | | | | | |
|---|---|---|---|---|---|---|---|---|
| S-1170: Sugar fatty acid ester | [mass %] | 95 | 90 | 75 | 40 | 25 | 0 | — |
| RIKEMAL S-100P: Glycerin | [mass %] | 5 | 10 | 25 | 60 | 75 | 100 | — |
| fatty acid ester | | | | | | | | |

Evaluation of coating liquid

| Liquid state | | B | B | A | A | B | C | — |
|---|---|---|---|---|---|---|---|---|
| | (mPa · s) | 3103 | 7730 | 258 | 1670 | 3427 | — | — |
| Shear viscosity at shear rate of 1 | (Pa · s) | 3.1 | 7.7 | 0.3 | 1.7 | 3.4 | — | — |
| (s⁻¹) | | | | | | | | |

Freshness-preserving effect on avocado

| Coating appearance | | | B | B | A | A | C | — | — |
|---|---|---|---|---|---|---|---|---|---|
| Weight retention rate | Day 0 | [%] | 100 | 100 | 100 | 100 | 100 | — | 100 |
| | 3 days | [%] | 99.1 | 99.1 | 98.6 | 98.4 | 99.0 | — | 96.1 |
| | 4 days | [%] | 98.8 | 98.8 | 98.0 | 97.8 | 98.6 | — | 94.7 |
| | 5 days | [%] | 98.6 | 98.7 | 97.9 | 97.4 | 98.4 | — | 93.6 |
| Weight loss rate | 4 days | [%] | 1.2 | 1.2 | 2.0 | 2.2 | 1.4 | — | 5.3 |

| | | | | | | | | |
|---|---|---|---|---|---|---|---|---|
| Exocarp color | Day 0 | A | A | A | A | A | — | A |
| | 3 days | A | A | A | A | A | — | B |
| | 4 days | A | A | A | A | A | — | C |
| | 5 days | A | A | A | A | A | — | C |

From the results shown in Table 1, it is found that the avocado coated with the coating composition of the present disclosure has a favorable coating appearance when coated, and exhibits good results in terms of both the weight retention rate and exocarp color when stored for 5 days.

Meanwhile, in Example 5, in which the mass ratio of the sucrose fatty acid ester to the glycerin fatty acid ester was outside the range of the present disclosure, the coating appearance was poor, but the freshness-preserving effect was exhibited without any problem. As indicated in Comparative Example 1, in the case in which a coating liquid not containing a sucrose fatty acid ester was used, the viscosity was high, and the shear rate failed to be measured. Therefore, a coating film failed to be formed on the avocados. Furthermore, in Comparative Example 2, in which no coating film was formed, weight loss was observed over time, and the color of the exocarp also deteriorated, and therefore, it was found that the freshness retention rate was clearly reduced.

These effects are presumably considered to be attributed to the fact that the fatty acid ester moieties of the glycerin fatty acid ester and sugar fatty acid ester contained in the composition were crystallized, resulting in a denser coating film that thereby exhibited gas barrier properties, and the fact that the structure of the aggregate formed from the glycerin fatty acid ester and the sugar fatty acid ester changed, and the coatability was improved by mixing the sugar fatty acid ester into the glycerin fatty acid ester.

### Examples 6 to 11 and Comparative Examples 2 to 4

Coating liquids were prepared in the same manner as in Example 1 with the exception that the sugar fatty acid ester and the glycerin fatty acid ester were changed to the components and compositions described in Table 2. The state of the coating liquid, the viscosity of the coating liquid, the state of the coating film, and the freshness retention of the coated avocados were evaluated, and the evaluation results are shown in Table 2.

In the differential scanning calorimetry of Example 6 at −80° C. or higher, there was no peak during temperature decrease, but during temperature increase, an exothermic peak of 85.39 J/g with a peak top at 65.7° C. was present in a range from 62° C. to 68° C. Therefore, A₁/A₂ was equivalent to A₃/A₂ and was 0%.

For an aqueous coating composition in which S-1170 of Example 8 was changed to the equivalent product of F-110, the ratio of A₃/A₂ at −80° C. or higher was 49%.

In differential scanning calorimetry of Example 10 at temperatures of −80° C. or higher, during temperature decrease, two exothermic peaks were present including an exothermic peak of 4.885 J/g in a range from 2° C. to −1° C. with a peak top at 1.1° C. and an exothermic peak of 32.9 J/g in a range from −29° C. to −32° C. with a peak top at −29.6° C., and during temperature increase, an exothermic peak of 32.07 J/g was present in a range from −27° C. to −25° C. with a peak top at −27.1° C. Moreover, an endothermic peak of 59.91 J/g having a peak top at 20.8° C. was present in a range of from 5° C. to 24° C., and an endothermic peak of 25.2 J/g having a peak top at 27.6° C. was present in a range from 24° C. to 30° C. In this case, A₃/A₂ was 82%.

In differential scanning calorimetry of Example 11 at temperatures of −80° C. or higher, during temperature decrease, two exothermic peaks were present including an exothermic peak of 4.358 J/g in a range from 2° C. to −2° C. with a peak top at 1.8° C. and an exothermic peak of 30.58 J/g in a range from −29° C. to −32° C. with a peak top at −29.7° C., and during temperature increase, an exothermic peak of 28.11 J/g was present in a range from −29° C. to −24° C. with a peak top at −26.4° C. Moreover, an endothermic peak of 57.56 J/g having a peak top at 21.0° C. was present in a range from 2° C. to 24° C., and an endothermic peak of 23.3 J/g having a peak top at 27.2° C. was present in a range from 24° C. to 30° C. In this case, A₃/A₂ was 78%.

TABLE 2

| | | | | | | | | |
|---|---|---|---|---|---|---|---|---|
| Exam- | Exam- | Exam- | Exam- | Exam- | Exam- | Comparative | Comparative | Comparative |
| ple 6 | ple 7 | ple 8 | ple 9 | ple 10 | ple 11 | Example 2 | Example 3 | Example 4 |

Liquid composition

| | | | | | | | | | | |
|---|---|---|---|---|---|---|---|---|---|---|
| Solid content concentration | [mass %] | 5.00 | 5.00 | 5.00 | 5.00 | 5.00 | 5.00 | — | 5.70 | 4.00 |
| S-1170: Sugar fatty acid ester | [mass %] | | | 1.00 | | | | — | | |
| S-1670: Sugar fatty acid ester | [mass %] | 1.00 | | | 0.05 | 0.25 | 0.45 | — | | |
| S-570: Sugar fatty acid ester | [mass %] | | 0.50 | | | | 0.05 | — | | |
| M-1695: Sugar fatty acid ester | [mass %] | | | | | | | — | 2.00 | 2.00 |
| RIKEMAL ® S-100P: | [mass %] | 4.00 | 4.50 | | | | | — | | |
| Glycerin fatty acid ester | | | | | | | | | | |
| POEM ® M-100: | [mass %] | | | 4.00 | 4.95 | 4.75 | 4.50 | — | | |
| Glycerin fatty acid ester | | | | | | | | | | |
| MCT oil: Glycerin | [mass %] | | | | | | | — | 2.50 | 2.50 |
| fatty acid ester | | | | | | | | | | |
| Tannic acid | [mass %] | | | | | | | — | | 1.20 |
| Ethanol | [mass %] | 0.00 | 0.00 | 0.00 | 0.00 | 0.00 | 0.00 | — | 50.00 | 50.00 |
| Ion-exchanged water | [mass %] | 95.00 | 95.00 | 95.00 | 95.00 | 95.00 | 95.00 | — | 45.50 | 44.30 |

Mass ratio of sugar-based surfactant to total mass of sugar-based surfactant and glycerin fatty acid ester

| | | | | | | | | | | |
|---|---|---|---|---|---|---|---|---|---|---|
| S-1170: Sugar fatty acid ester | [mass %] | | | 20 | | | | — | | |
| S-1670: Sugar fatty acid ester | [mass %] | 20 | | | 1 | 5 | 9 | — | | |
| S-570: Sugar fatty acid ester | [mass %] | | 10 | | | | 1 | — | | |
| M-1695: Sugar fatty acid ester | [mass %] | | | | | | | — | 44 | 44 |
| RIKEMAL S-100P: | [mass %] | 80 | 90 | | | | | — | | |
| Glycerin fatty acid ester | | | | | | | | | | |
| POEM ® M-100: | [mass %] | | | 80 | 99 | 95 | 90 | — | | |
| Glycerin fatty acid ester | | | | | | | | | | |
| MCT oil: Glycerin | [mass %] | | | | | | | — | 56 | 56 |
| fatty acid ester | | | | | | | | | | |

Evaluation of coating liquid

| Liquid state | | A | A | B | A | A | A | — | C | C |
|---|---|---|---|---|---|---|---|---|---|---|
| Shear viscosity at | (mPa · s) | 125 | 841 | 3099 | 83 | 3 | 332 | — | | |
| shear rate of 1 (s⁻¹) | (Pa · s) | 0.125 | 0.841 | 3.099 | 0.083 | 0.003 | 0.332 | — | | |
| DSC evaluation | [%] | 0.0 | | 49.2 | | 82.1 | 78.0 | — | | |
| results | | | | | | | | | | |

Freshness-preserving effect on avocado

| Coating appearance | | | A | A | A | A | A | A | — | B | B |
|---|---|---|---|---|---|---|---|---|---|---|---|
| Weight retention rate | 4 days | [%] | 97.5 | 98.0 | 96.3 | 96.1 | 96.2 | 96.3 | 94.7 | 73.2 | 74.6 |
| Weight loss rate | 4 days | [%] | 2.5 | 2.0 | 3.7 | 3.9 | 3.8 | 3.7 | 5.3 | 26.8 | 25.4 |

| | | | | | | | | |
|---|---|---|---|---|---|---|---|---|
| Exocarp color | 4 days | A | A | A | B | B | A | C |
| Fruit hardness | 4 days | 13 | 10 | 32 | 8 | 6 | 8 | 5 |

| | | | | | | | | | |
|---|---|---|---|---|---|---|---|---|---|
| Texture of fruit surface after coating | A | A | A | A | A | A | — | B | B |

From the results shown in Table 2, it was found that the coating composition of the present disclosure was in a uniform state without the occurrence of precipitation, separation, or the like, and therefore, the coating treatment was stably performed. Moreover, the avocado to which the coating composition of the present disclosure was applied had a good coating appearance when the coating composition was applied, and exhibited good results in terms of all of the weight retention rate, the exocarp color, and the fruit hardness when stored for 4 days. From the results of Examples 1 to 11 and Comparative Examples 3 and 4, it was found that the coating composition was a stable liquid when the proportion of the triester in the coating composition was low.

The coating compositions of Examples 6, 7, 9, and 10 exhibited a uniform state with fluidity, whereas the coating composition of Comparative Example 1 was in a non-uniform state without fluidity, and thus it was found that when a certain amount or more of a sucrose fatty acid ester is blended with a glycerin fatty acid ester, the coating composition exhibits physical properties suitable for use in coating. The reason for this is thought to be that the glycerin fatty acid ester, which did not form a stable coating solution by itself, was changed to a usable state as a coating liquid by being mixed with a certain proportion or more of a sucrose fatty acid ester having a similar structure and having a fatty acid ester in the structure. In particular, it was found that when the proportion of the sucrose fatty acid ester is 10 mass % or more in the mass ratio of the sucrose fatty acid ester and glycerin fatty acid ester in the coating composition, an effect of suppressing ripening such as a change in the exocarp color and a decrease in the hardness of an avocado is enhanced.

Moreover, in Examples 6, 8, 10, and 11, a higher freshness-preserving effect was exhibited as the ratio of A₃/A₂ obtained from the differential scanning calorimetry results at −80° C. or higher became smaller. In Example 10, in which A₃/A₂ was 82.1%, weight loss, change in exocarp color, and fruit softening were suppressed as compared with Comparative Example 2, in which no coating treatment was carried out. Meanwhile, the results of Example 11, in which A₃/A₂ was 78.0%, indicated a further suppression of change in the exocarp color and of fruit softening, the results of Example 8, in which A₃/A₂ was 49.2%, indicated yet a further suppression of change in the exocarp color and of fruit softening, and the results of Example 6, in which A₃/A₂ was 0%, indicated, in addition to the above, a suppression in weight loss. In differential scanning calorimetry, when the liquid component changes to a solid component as the temperature is changed, an exothermic peak appears, and therefore the ratio of the exothermic peak to the endothermic peak is considered to be one aspect that represents the amount of liquid component. The film formed on the fruit surface suppresses the permeation of oxygen gas and water vapor, and as a result, weight loss and the progression of ripening are suppressed. When the amount of the liquid component in the substance constituting the film component increases, the permeation of the gas component also increases. Therefore, from the viewpoint of freshness preservation, it is considered that a smaller ratio of the exothermic peak to the endothermic peak, the ratio thereof representing the liquid component, is more desirable.

From the above, it was demonstrated that the coating composition of the present disclosure can be particularly suitably used on fruits and vegetables.

### INDUSTRIAL APPLICABILITY

According to the present disclosure, when fruits and vegetables are covered with a coating film that is highly safe and exhibits a high water vapor barrier property, the transpiration of moisture from the fruits and vegetables is suppressed, and the freshness can be maintained over a long period of time. That is, since the freshness of the fruits and vegetables is maintained for a long period of time, there is no need for farmers or the like to ship the fruits and vegetables earlier than necessary when harvested, and a benefit of consumers being able to obtain fruits and vegetables excelling in freshness can be obtained. Therefore, the industrial value of the technology is high.

1. A coating composition comprising a sugar-based surfactant and a glycerin fatty acid ester, wherein
a mass ratio (solid content) of the sugar-based surfactant to a total mass of the sugar-based surfactant and the glycerin fatty acid ester is 1% or more and less than 100%, and
a content of a glycerin fatty acid ester having three fatty acid ester groups is 50 mass % or less.

2. The coating composition according to claim 1, wherein a shear viscosity at a shear rate of 1 s⁻¹ is from 0.1 to 8000 mPa·s.

3. The coating composition according to claim 1, wherein the sugar-based surfactant comprises a sucrose fatty acid ester.

4. The coating composition according to claim 1, further comprising an aqueous solvent.

5. The coating composition according to claim 4, wherein the aqueous solvent contains water or a mixed solvent of a water-soluble organic solvent and water.

6. The coating composition according to claim 1, wherein a concentration of a nonvolatile component in the coating composition is 0.1 mass % or more and 60 mass % or less.

7. The coating composition according to claim 1, wherein, in differential scanning calorimetry in which a measurement temperature range is set to −80° C. or higher, a ratio of a total exothermic peak area A₃ to a total endothermic peak area A₂ at 0° C. or higher and 80° C. or lower is 50% or less.

8. A fruit or vegetable comprising a coating film including the coating composition according to claim 1.

9. The fruit or vegetable having a coating film according to claim 8, wherein the coating film has an average film thickness of 0.1 μm or more and 10 μm or less.

10. A method for preserving a freshness of a fruit or vegetable, the method comprising covering the fruit or vegetable with the coating composition according to claim 1.

11. The method for preserving a freshness of a fruit or vegetable according to claim 10, wherein the covering with the coating composition includes immersing the fruit or vegetable in the coating composition, or applying or spraying the coating composition onto the fruit or vegetable.
